(19) United States
(12) Patent Application Publication
(10) Pub. No.: US 2012/0227900 A1
(43) Pub. Date: Sep. 13, 2012

(54) Process for coupling a polymeric component to a metal component forming part of or a biomedical joint prosthesis

(75) Inventor: Gianluca Zappini, Pergine Valsugana (Trento) (IT)

(73) Assignee: EUROCOATING S.P.A., Pergine Valsugana (Trento) (IT)

(21) Appl. No.: 13/508,539

(22) PCT Filed: Nov. 12, 2010
(86) PCT No.: PCT/IB2010/055148

§ 371 Date: May 17, 2012

(30) Foreign Application Priority Data
Nov. 13, 2009 (IT) VR2009A000190

(51) Int. Cl. B29C 65/52

(52) U.S. Cl. 156/272.6; 156/303.1; 156/283

(57) ABSTRACT

A process for coupling a polymer component to a metal component forming part of a biomedical joint prosthesis includes the steps of providing the polymer component, providing the metal component having a surface with the same geometry/curvature of the surface of the polymer component to be coated, putting in contact the polymer component with the metal component, and heating only the metal component to a process temperature equal to or higher than the melting temperature of the polymer component to achieve a local softening or melting of the polymer component at the contact surface between the two components.

### TECHNICAL FIELD OF THE INVENTION

The invention concerns a process for coupling a polymer component to a metal component forming part of a biomedical joint prosthesis, and the prosthesis thus obtained.

### PRIOR ART

In the field of orthopaedic surgery various endoprostheses have been studied to replace different skeletal components or portions thereof (knee, hip, shoulder, fingers, elbows, vertebral column, etc . . . ), so as to give them back their joint function and to reflect the morphology of the part they will replace as much as possible.

Many of such endoprostheses are formed by two components that are articulated with one another, each of such components having an articulating part and an anchoring part: the articulating part is in contact with the corresponding articulating part of the opposite prosthetic component, whereas the anchoring part is in contact with the bone.

Often, one of the articulating parts is made from a polymeric material and is opposed to the articulating part in metal or ceramic material of the second prosthetic component.

The polymeric material that is usually used is polyethylene having very high molecular weight (UHMWPE: Ultra High Molecular Weight Polyethylene), which offers a very low friction coefficient and a high wear resistance. Recently, other polymers have been proposed on the market, such as PEEK (polyetheretherketone), PEEK reinforced with carbon fibres, polycarbonates and polyurethanes. UHMWPE still remains, in any case, the most widely used polymeric material.

Due to its low osteointegrative capacity and to its low rigidity, polyethylene UHMWPE is coupled with a metal layer (also called “metal back”), so that the articulating part and the anchoring part of the prosthetic component consist of two different materials.

For example, many tibial plates, like that in FIG. 1, are made up of an articulating part 10 of polyethylene coupled with a metal support 12 that is in contact with the bone 14; acetabular cups, like that in FIG. 2, have a metal anchoring shell 20 containing an insert 22 made from polyethylene.

A problem deriving from this type of coupling are the micromovements between the component made from polyethylene and the metal support component. Since adhesives are not used, the two assembled components can slightly move with respect to one another and can locally detach, leading to a possible risk of instability of the prosthesis.

Another problem is the wearing between the polymer insert and the metal base that leads to the abrasion of the polymer surface, which is a drawback known as “backside wear” especially in tibial components.

In order to avoid such drawbacks, it would be ideal to be able to directly cover the polyethylene element with a metal layer, thus obtaining a stable interface.

EP0761242 describes the method for coating polymer components with a titanium coating through thermal spray, but this is only possible with polymers having a high melting point such as poly(aryl ketone) described here, and not with polyethylene: the temperatures reached during the thermal spray would indeed make the polyethylene melt, deforming it and degrading its mechanical properties.

EP1082074 describes the coupling of a metal mesh with acetabular cups of polyethylene, this however, does not guarantee the rigidity of the prosthetic component, that given how thin and easy to deform the metal mesh is, remains low.

EP0726066 describes a prosthesis of an acetabular cup made by joining three components or shells: initially the inner shell is joined with a polymer component, by inserting the shell in a mould and injecting the polymer, or compressing the shell in a polymeric preform preheated to the molten state.

The polymer part, in this patent application, constitutes however, only a preform, that must be worked into the final shape, to be able to be inserted in a third outer metal shell.

Therefore, whereas the first inner shell is firmly coupled with the polymer component due to the presence of undercuts, the outer shell is not firmly anchored.

Therefore, the solution described in EP0726066 does not eliminate the possibility of micromovements and prosthesis instability.

U.S. Pat. No. 4,104,339 describes the method of inserting a metal wire in a thermoplastic component (intraocular lens), by heating the metal wire to a temperature slightly higher than the melting temperature of the thermoplastic, thus causing there to be a local fusion that allows the metal wire itself to be inserted.

Such a process provides satisfactory results only in the case in which polymeric materials with a low viscosity in the molten state are used.

Differently from intraocular lenses, orthopaedic components are essentially made up of UHMWPE, which has a viscosity, in the molten state, that is too high to allow metal parts to be inserted.

EP1800700 describes the manufacture of metal structures through laser sintering. Such structures consist of porous surface layers and an inner body that is not porous, therefore with at least 3 layers having variable porosity. By placing a metal component of this type in contact with a polymer component in a shape or cavity, and by applying heat and pressure from outside, it is possible, according to EP1800700, to make the polymer and metal compenetrate each other. The polymer can be in powder, or be a finished component. If a finished component is available, the process does not consider however the fact that by heating the polymer component above its melting temperature and by applying an outer pressure, the entire polymer component deforms, inner stress is generated due to thermal expansion and the risk of thermal oxidation of the polymer itself is increased, especially when the polymer used is UHMWPE, which is characterised by a high viscosity and therefore requires high pressure to obtain the compenetration in the metal component.

### PURPOSES OF THE INVENTION

The general purpose of the invention is to devise a method that improves the state of the art. Another purpose is to produce medical prostheses that last longer and that are of greater quality.

These purposes are achieved with a process for coupling a polymer component to a metal component forming part of or a biomedical joint prosthesis, comprising the steps of

providing said polymer component,

providing said metal component having a surface with the same geometry/curvature of the surface of the polymer component to be coated,

putting in contact the polymer component with the metal component,

heating only the metal component to a process temperature equal to or higher than the melting temperature of the polymer component to achieve a local softening or melting of the polymer component at the contact surface between said two components.

With the process according to the invention, it is possible to couple the polymer component, for example of polyethylene, with the metal component. The reciprocal contact surface is increased creating a compenetration between the two materials at the interface, exploiting the viscous/adhesive properties of the polymer in the molten state and the thermal conducting properties of the metal.

Only the metal component is heated, so as to avoid the deformation of the entire polymer component, since only the area at the interface melts.

In an embodiment of the process according to the invention, the step of putting in contact the polymer with the metal occurs before the step of heating the metal component.

Polymer components that are suitable for the process are for example those made from UHMWPE or PEEK or PEEK reinforced with carbon fibres, from polycarbonates or from polyurethane.

As far as the metal component is concerned, all metals currently used in orthopaedics are suitable for the purpose, preferably titanium, titanium alloys, stainless steel, cobalt-chromium alloys, tantalum, tantalum alloys, niobium, niobium alloys.

Preferably in the heating step the further step of pressing said two components against one another is carried out so as to promote the compenetration thereof along the contact surface.

It should be noted that, thanks to the heating of only the metal component, pressure can be applied, improving the adhesion, but avoiding the deformation of the entire polymer component.

The metal component can be a volume of powdered material to be sintered or a finished component.

In order to facilitate the adaptation between polymer and metal component, the metal component can be a body having a surface with the same geometry/curvature of the surface of the polymer component to be coated. Basically, a shape coupling is obtained.

Preferably, in order to improve the tenacity of the interface, the metal component on said surface with the same geometry/curvature exhibits roughness or porosities or retentive elements or undercuts so as to increase the contact surface. See for example the content of PCT/IB2008/002261 for a method to increase the contact surface.

In a further version of the invention, in order to facilitate the adaptation between the polymer component and the metal component, the metal component can have a surface with the same geometry/curvature of the surface of the polymer component to be coated. Basically a shape coupling occurs.

In a further version, the polymer component and the metal components substantially have corresponding and comparable dimensions.

It may be that there is not an optimal union, for example, when the polyethylene of the implants is UHMWPE that, even in the molten state, has a very high viscosity. In order to make the powders or the metal component compenetrate, it would thus be necessary to have a very high pressure, which would deform the entire component.

In order to solve this problem of a possible low adhesion between the metal and polymer component, before the step of putting them in contact with one another, the polymer component and/or the metal component is coated or covered with a film or powders of a polymer having a sealant function with greater fluidity than the polymer component in the molten state. In the heating step, the metal component is then heated to a process temperature higher than or equal to the melting temperature of said sealant polymer, so as to obtain a local fusion or softening of said sealant polymer at the contact surface between said two components.

The sealant polymer acts as an intermediate bonding layer. Since it has greater fluidity than the polymer component, it improves the contact and the connection between polymer and metal component. Moreover, since it requires less pressure to flow with respect to the polymer component, it avoids the need to use too high pressures which could alter the dimensions of the polymer component.

In particular, the sealant polymer should be selected based on the polymeric material of the initial component: the melting temperature of the sealant polymer Ts should not be higher than Tp+50° C., where Tp is the melting temperature of the polymeric material forming the initial component. Very preferably, Ts should be lower than or equal to Tp.

The film or the powders of the sealant polymer are preferably selected from the group consisting of polyolefin, polyester, polysulfones, polyketones, polyimides, polymethacrylates, polycarbonates, polyurethanes or copolymers thereof.

The process can, in any case, be extended to other polymeric materials used in orthopaedics as well.

In particular, since a component in UHMWPE has to be joined to a metal component, the film or the powders of the sealant polymer are preferably selected from the group consisting of high density polyethylene (HDPE), low density polyethylene (LDPE), very low density polyethylene (LLDPE), linear polyethylene (LPE), high molecular weight polyethylene (HMWPE), very high molecular weight polyethylene (UHMWPE) or a mixture of these polymers.

The heating step of the process described herein can be carried out for example by inducing a circulation of current inside the metal component: since the metal has high electric and heat conductivity and since the polymer has low electric and heat conductivity, the heat generates inside the metal component by Joule effect to the metal/polymer interface; the surface of the polymer component is heated as well through radiation or through contact, whereas the rest of the polymer component remains at much lower temperatures. The pressure described in the pressing step can be applied to the two components for example through a press, so as to induce the compenetration of the two components and/or the melting and the fluidification of the sealant polymer.

Any device, apparatus or group of apparatuses capable of inducing such phenomena, is suitable for joining the two components.

As a preferred variant, the heating and pressing steps are made by SPS (Spark Plasma Sintering), due to the facility with which it is possible to integrate the heating and pressing steps. As a matter of fact, in the SPS process, pressure is applied naturally to the mould, and the currents circulating in the mould itself and in the metal component heat the metal parts and also the interface between metal and polymer component through Joule effect.

SPS has the further advantage of providing a fast heating (ranging from 20 to 500° C./min) and exactly where it is necessary, i.e. at the metal-polymer interface.

The SPS process can provide a further advantage when both the metal component and the sealant polymer are initially in the form of powders: the passage of current in the metal powders generates plasma between metal particles that increase the temperatures of the adjacent particles of sealant polymer, leading them to melt and promoting the incorporation of the metal particles. When there is direct contact between metal particles, the generation of such plasma combined with the outer pressure can lead to the welding of such metal particles, thereby increasing the cohesion of the final metal layer.

The invention further concerns the prosthesis obtained according to the aforementioned process.

The process of the invention is particularly suitable for making as a resulting component, (but not only), an acetabular cup, the tibial plate of a knee prosthesis, the patellar component of a knee prosthesis, the glenoid component of a shoulder prosthesis, the humerus component of a reverse shoulder prosthesis, a prosthetic inter-vertebral disc, the radial component of a prosthetic elbow, the component of a prosthesis of wrist or ankle, the phalangeal prosthetic joints of the hand and foot.

### BRIEF DESCRIPTION OF THE DRAWINGS

Further characteristics and advantages of the invention shall become clearer from the description given as an example of a process, together with the attached drawings in which:

FIG. 1 shows a known tibial component of a knee prosthesis;

FIG. 2 shows the section of a known acetabular cup of a hip prosthesis;

FIG. 3 shows a cutaway view of one of the possible mould schemes used in a process according to the invention.

FIG. 3 shows a mould formed by a matrix 32 and a punch 30 made of conductive material (for example graphite) of a sintering machine through SPS. Inside it, a component made from UHMWPE 40, a layer of HDPE 42 and a metal component 44 are arranged on top of one another.

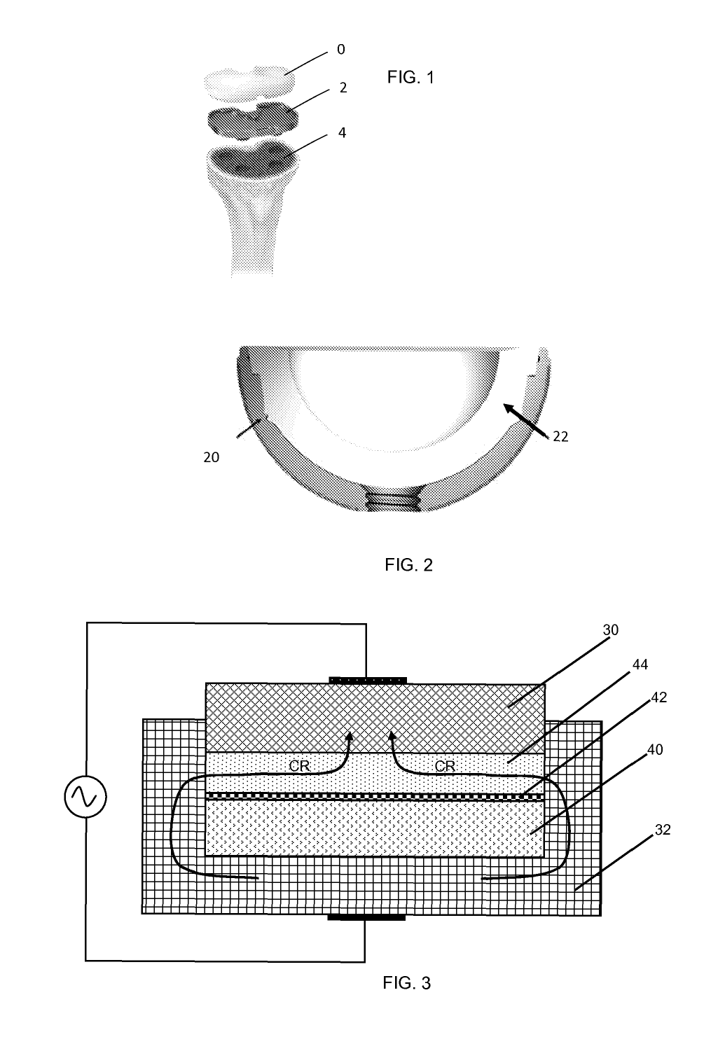

The layer 42 has a greater fluidity than the component 40 in the molten state.

During the process, an axial pressure is applied from outside onto the matrix 32 and on the punch 30; a pulsating current CR is generated in a known way and is sent to the matrix and to the punch. The arrows indicate a possible direction of the current.

The currents CR heat by Joule effect in a rapid and even manner only the component 44, which transfers heat to the layer 42, melting it.

The layer 42, in addition to thermally shielding the component 44, fluidifies much more than it and melts completely. The pressure applied to the mould between the punch 30 and the matrix 32 improves the adhesion and the uniformity of the layer 42 between the components 40, 44.

In brief a finished component, made up of three elements 40, 42, 44 which are perfectly welded to one another, is obtained.

The invention claimed is:

1. Process for coupling a polymer component to a metal component forming part of or a biomedical joint prosthesis, comprising the following steps:
providing said polymer component;
providing said metal component having a surface with a same geometry or curvature of a surface of the polymer component to be coated;
putting in contact said polymer component with said metal component; and
heating only the metal component at a process temperature equal to or higher than the melting temperature of the polymer component in order to achieve a local softening or melting of said polymer component at a contact surface between the metal component and the polymer component.

2. Process according to claim 1, wherein, during the heating step, a step of pressing the metal component and the polymer component against one another is carried out to facilitate their compenetration along the contact surface.

3. Process according to claim 1, wherein the metal component is a finished component.

4. Process according to claim 1, wherein the metal component on said surface with the same geometry or curvature has roughness, porosity, retentive elements, or undercuts in order to increase the contact surface.

5. Process according to claim 1, wherein the metal component is a volume of powder material.

6. Process according to claim 1, wherein before the step of putting in contact, one or more of the polymer component or the metal component is coated or covered with a film or powders of a polymer having a sealant function with greater fluidity than the polymer component in molten state, and during the heating step the metal component is heated to a process temperature higher than or equal to the melting temperature of said sealant polymer, in order to obtain a local softening or melting of said sealant polymer at the contact surface between the metal component and the polymer component.

7. Process according to claim 6, wherein the film or powders of the sealant polymer are selected from the group consisting of polyolefins, polyesters, polysulfones, polyketones, polyimides, polymethacrylates, polycarbonates, polyurethanes, and copolymers thereof.

8. Process according to claim 6, wherein the film or powders of the sealant polymer are selected from the group consisting of high density polyethylene (HDPE), low density polyethylene (LDPE), very low density polyethylene (LLDPE), linear polyethylene (LPE), high molecular weight polyethylene (HMWPE), very high molecular weight polyethylene (UHMWPE), or a mixture thereof.

9. Process according to claim 2, wherein the heating step and the pressing step are carried out by Spark Plasma Sintering.

10. Process according to claim 1, wherein the metal component is selected from the group consisting of titanium, titanium alloys, stainless steel, cobalt-chromium alloys, tantalum, tantalum alloys, niobium, and niobium alloys.

11. Process according to claim 1, further comprising the step of producing an acetabular cup, a tibial plate of a knee prosthesis, a patellar component of a knee prosthesis, a gleonid component of a shoulder prosthesis, a humerus component of a reverse shoulder prosthesis, a prosthetic inter-vertebral disc, a radial component of a prosthetic elbow, a component of a prosthesis of wrist or ankle, or a phalangeal prosthetic joints of the hand and foot.
